(19) United States
(12) Patent Application Publication
(10) Pub. No.: US 2016/0191693 A1
(43) Pub. Date: Jun. 30, 2016

(54) SYSTEMS AND METHODS FOR PROVIDING A WIRELESS ROUTER HIGH GAIN DUAL POLARIZED ANTENNA

(71) Applicant: JUAN ZAVALA, Temecula, CA (US)

(72) Inventor: JUAN ZAVALA, Temecula, CA (US)

(21) Appl. No.: 14/798,385

(22) Filed: Jul. 13, 2015

Related U.S. Application Data
(60) Provisional application No. 62/024,355, filed on Jul. 14, 2014.

(51) Int. Cl. H04M 1/725; H04W 72/04

(52) U.S. Cl. CPC H04M 1/72527; H04W 72/0446

(57) ABSTRACT

Systems and methods for providing an antenna device for employment with conventional wireless routers and more particularly, wireless routers which perform as what is known as mobile hotspots providing network access to a plurality of wirelessly communication computing devices such as portable computers and smartphones.

### RELATED APPLICATIONS

This application claims priority to U.S. Provisional Patent Application Ser. No. 62/024,355 filed Jul. 14, 2014, entitled WIRELESS ROUTER HIGH GAIN DUAL POLARIZED ANTENNA, which is incorporated herein by reference.

### BACKGROUND OF THE INVENTION

1. Field of the Invention

The present invention relates generally to wireless communications. More particularly, the invention relates to an antenna device for employment with conventional wireless routers and more particularly, wireless routers which perform as what is known as mobile hotspots providing network access to a plurality of wirelessly communication computing devices such as portable computers and smartphones.

2. Background and Related Art

Electronic devices such as smart phones, cell phones, laptops, tablets, and the like, conventionally communicate with cellular towers, computer networks, wireless modems and routers, Bluetooth receivers and other networking components using wireless radio frequency (RF) communication. This is accomplished through the employment of one or a plurality of antennas having radiator or antenna elements electronically integrated into the devices and configured to the task of transmitting and receiving at pre-determined frequency wavelengths for the desired purpose.

The frequency band of communication can vary widely depending on the type of wireless communications being implemented in a wireless grid or network, such as cellular or WiFi or digital communications for emergency services. The system requirements for gain, and individual employed frequencies can also vary depending on the FCC and client's needs. Also, a horizontal, vertical, or circular polarization scheme that may be desired to either increase bandwidth or connections.

One such conventional wireless communication in the form of a wireless router also called “MiFi” has in recent years become ever more popular. Such wireless routers or MiFi units conventionally communicate with a cellular telephone network using cellular telephone frequencies to gain access to achieve a connection to the internet or private computer networks.

With such a connection achieved, the wireless router or MiFi device then acts as a router to provide communication between the MiFi unit itself and one or a plurality of computing devices using conventional local wireless router frequencies. The connected computing devices and other wireless devices thus achieve a wide-area=network connection over the internet or a private network, through their local wireless communication with the MiFi units or wireless router.

Most such MiFi units or wireless routers conventionally use a single connection to the cellular system to send and receive data to and from multiple computing devices and/or smartphones. As such the communication to and from the connected devices is dependent on the quality and bandwidth of the connection of the MiFi unit or wireless router, to the local cellular telephone system. If that connection is poor, then communications to and from the connected devices will be very slow and prone to errors and failure.

Currently available MiFi units which are conventionally purchase or leased from cellular providers along with some type of connection subscription, have antennas positioned within a surrounding plastic housing. Consequently, such antennas are prone to low gain due to their interior positioning and size as well as their polarization scheme.

Even with the advancements in the technology of smart phones pad computers, and other portable computing devices, MiFi users often continue to experience poor cellular reception. This is contributed wholly or in part by the availability and quality of cellular grids in a certain area provide by cellular communication firms, as well as the quality of the antenna of the receiving device itself. Cellular providers are often limited to the quantity and location of which a cellular grid can be built. These grids are often considered eye-sores in neighborhood and public areas. Therefor adding more or constructing larger grids to provide improved cellular reception to customers is often limited.

Further, to manufacture MiFi units and wireless routers for RF communication with stronger and better antennas tends to drive cost up for the manufactures which is translated to undesirable increased cost to the customer.

As a consequence of the poor quality of reception and transmission by these housing-covered antennas included with such MiFi units and wireless routers, and the wide variations in signal strength from the local cellular grid to which they connect, the bandwidth and speed of data communication to and from connected MiFi and router users can tend to be very slow and prone to disconnections and errors.

Thus, while techniques currently exist relating to wireless technologies, challenges still exist. Accordingly, it would be an improvement in the art to augment or even replace current techniques with other techniques.

### SUMMARY OF THE INVENTION

The present invention relates generally to wireless communications. More particularly, implementation of the present invention relates to an antenna device for employment with conventional wireless routers and more particularly, wireless routers which perform as what is known as mobile hotspots providing network access to a plurality of wirelessly communication computing devices such as portable computers and smartphones.

At least some implementations relate to an antenna device for improving RF reception and transmission for MiFi routers and other wireless routers using the cellular grid or other wireless networks to connect to the internet or a private network, and provide downstream connections to a plurality of computing devices. Such a device is configured for easy engagement to existing antenna ports on such MiFi devices and routers. Further, such a device improves the communications with the cellular grid and improves the bandwidth and data transmission rate between the MiFi unit and connected devices concurrently.

Implementations of the present invention embrace an antenna device which is uniquely shaped and configured to easily connect to existing antenna ports of Wifi units and wireless routers which communicate with a cellular network.

In accordance with a first preferred mode, the device includes a novel radiator element operatively engageable with an antenna jack or port, which will improve the transmission and reception capabilities of the Mifi unit or wireless router on the cellular frequencies, as well as improve the multiple communication streams between the device and connected computers and smartphones.

The radiator element of the instant invention is based upon a wideband planar antenna element formed by printed-circuit technology or other means for placement of a conductor on a dialectic substrate to form the antenna. The antenna is of two-dimensional construction and is formed on a dialectic substrate of such materials as MYLAR, fiberglass, REXLITE, polystyrene, polyamide, TEFLON, fiberglass or any other such material suitable for the purpose intended. The substrate may be flexible whereby the antenna can be rolled up for storage and unrolled into a planar form for use. Or, in a particularly preferred mode of the device herein, it is formed on a substantially rigid substrate material in the planar configuration thereby allowing for components that both connect, and form the resulting rigid antenna structure.

The antenna radiator element, ground plane, and feedline formed on the substrate, can be any suitable conductive material, as for example, aluminum, copper, silver, gold, platinum or any other electrical conductive material suitable for the purpose intended. The conductive material forming the element is adhered or formed onto to the substrate by any known technology.

In a particularly preferred embodiment, the antenna radiator element is formed on one side of the substrate in registered positioning with

On the opposite surface of the substrate from the formed radiator element, a ground plane is engaged at a position substantially covering the area of the feedline of the first surface of the substrate. The positioning and configuration of the ground plane provides a means to block outside RF interference from interrupting a signal transmitting down the feedline.

Of course those skilled in the art will realize that various aspects of the invention be adjusted to increase gain in certain frequencies, improve impedance matching, or for other reasons known to the skilled, and any and all such changes or alterations of the depicted radiator element as would occur to those skilled in the art upon reading this disclosure are anticipated within the scope of this invention.

In a preferred as used mode of the invention, coupling of the device to a wireless router or WiFi unit is accomplished by engagement of a connector on the antenna device to a complimentary connector on the wireless router or MiFi unit.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device.

It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

It is an object of the invention to provide an antenna device which can be coupled to the existing antenna connector for a cellular or network wireless router.

It is an object of the invention to provide an antenna which will substantially increase the gain of the received and transmitted signal to and from a MiFi or other wireless router unit which connects to a network.

It is an object of the invention to provide such an antenna which in addition to increasing signal gain from and to the cellular network, will also increase throughput from the WiFi unit to connected computing devices.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a perspective view of the exterior of the antenna device herein having a plastic or other casing surrounding the underlying teardrop shaped antenna element and a projecting connector adapted to engage a mating connector of a MiFi unit;

FIG. 2 illustrates a perspective view of the device of FIG. 1, operatively engaged with a wireless router such as a MiFi unit showing the currently preferred inverted teardrop shape;

FIG. 3 illustrates a top plan view of a first side of the substrate having a conductive surface formed thereon and channels formed therein;

FIG. 4 illustrates a view of the second side of the substrate opposite the first, and depicting the areas covered by conductive material in registered positions relative to the first side;

FIG. 5 illustrates a view of the antenna device where the first side is depicted in a registered positioning and overlay of components on the second side which are shown in dotted line;

FIG. 6 illustrates another view of the antenna device of FIG. 5, where the first side is depicted in a registered positioning and overlay of components on the second side which are shown in dotted line;

FIG. 7 illustrates a sectional view showing a current preferred mode of the device herein and the registered layered engagement;

FIG. 8 illustrates a graph of transmit and receive characteristics of a conventional MiFi unit with a conventional antenna and the improvement in such with the antenna device herein engaged;

FIG. 9 shows another comparison of performance characteristics of a MiFi unit with an OEM antenna and the improvement provided by engagement of the antenna device herein; and

FIG. 10 shows a graph of the efficiency of the antenna device herein over various frequency ranges.

### DETAILED DESCRIPTION OF THE INVENTION

The present invention relates generally to wireless communications. More particularly, the invention relates to an antenna device for employment with conventional wireless routers and more particularly, wireless routers which perform as what is known as mobile hotspots providing network access to a plurality of wirelessly communication computing devices such as portable computers and smartphones.

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

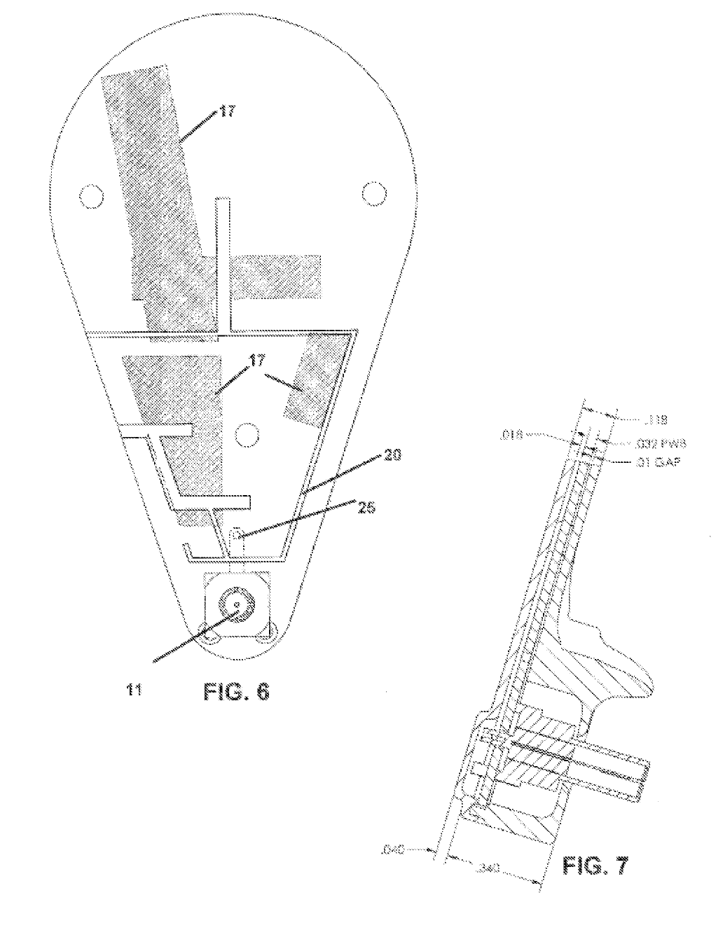

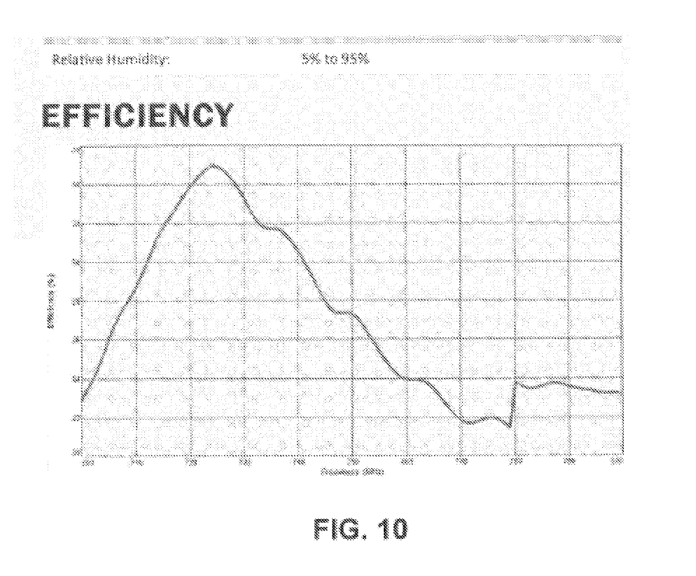

Now referring to drawings in FIGS. 1-10, wherein similar components are identified by like reference numerals, there is seen in FIG. 1 a perspective view of the antenna device 10 herein having a connector 11 for mating with a complimentary connector of a MiFi unit 15, projecting from a plastic casing 14. The disclosed device 10 works particularly well in the frequency range from 450 to 960 MHZ and can be adjusted to other frequencies in multiple polarizations by changing the size and or positioning of the elements 17. The casing 14 is of a similar inverted teardrop shape as the housed antenna device 10 and provides protection and structure for the antenna device 10 allowing it to be portable and engageable to multiple wireless routers 15 and in particular, cellular wireless routers known as MiFi devices, if desired.

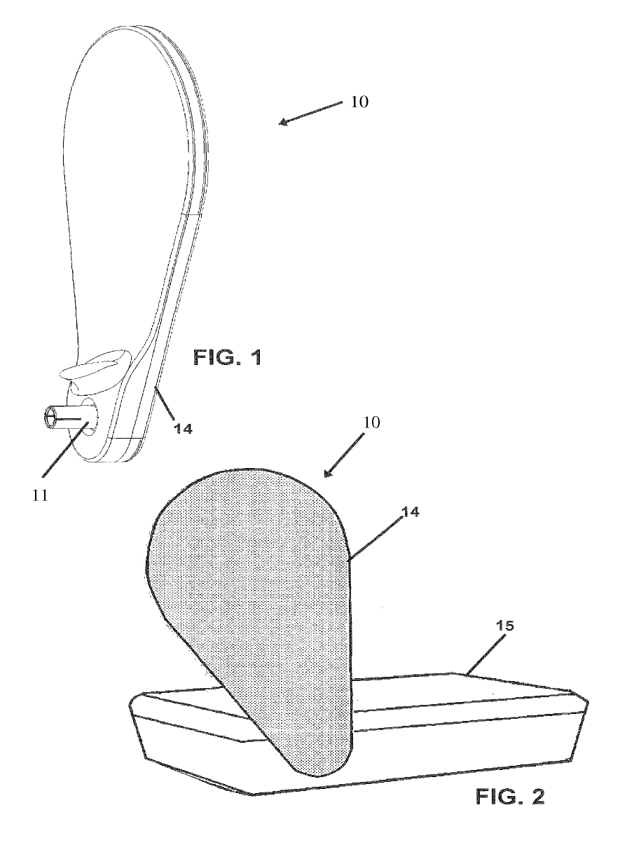

FIG. 2 shows the antenna device 10, in operative engagement with wireless router 15 or MiFi device. The device 10 is configured to engage with the conventional coaxial connectors for auxiliary or primary antennas used for such wireless routers 15 and in particular provided on MiFi devices sold and marketed by such firms as VERIZON wireless for subscribers needing wireless internet or network connections for a plurality of devices such as computers and tablets.

The device 10 as shown in a particularly preferred mode in FIGS. 1-6, is a planar wideband antenna having an inverse teardrop shape in the as-used position shown in FIGS. 1-2. It is formed on a planar substrate 12 which as noted is non-conductive and may be constructed of either a rigid or flexible material such as, MYLAR, fiberglass, REXLITE, polystyrene, polyamide, TEFLON fiberglass, or any other such material which would be suitable for the purpose intended.

A first surface 14 is coated with a conductive material 16 by microstripline or the like or other metal and substrate construction well known in this art. Any means for affixing the conductive material to the substrate is acceptable to practice this invention. The conductive material 14 as for example, includes but is not limited to aluminum, copper, silver, gold, platinum or any other electrical conductive material which is suitable for the purpose intended.

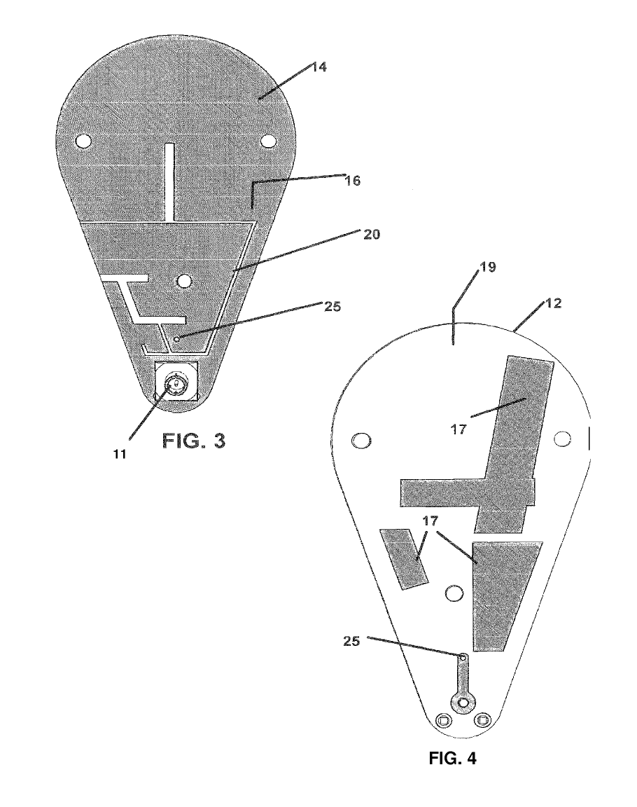

As shown in FIG. 1 the surface conductive material 16 on first surface 14 is coated to form the pathway for the feedline 20 or RF signal pathway area positioned on the first surface 14 to be in registered engagement and positioning with the elements 17 formed on the second surface 19. The teardrop shape of the first surface 14 with the conductive material 16 covering the majority of area, provides a preferred mode for the communication of RF energy to and from the formed elements 17 positioned on the second surface 19 of the device 10. The connector 11 shown in FIG. 3 is in operative communication with the pickup 25 communicating through the dielectric substrate providing the planar area for affixing and registering the first and second surface 19.

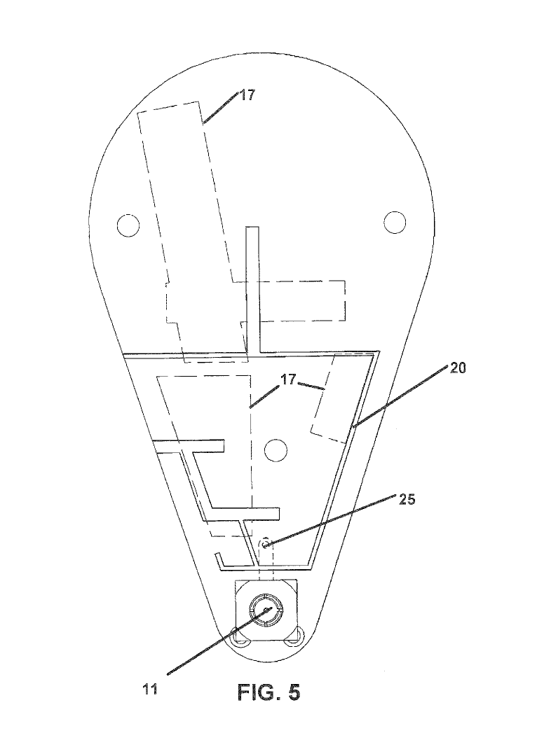

FIGS. 5-7 better depict the registered positioning of the feedline 20 and conductive surface 16 with the formed elements 17 on the second surface 19 of the planar substrate 12. Unlike conventional antennas used for wireless routers and especially MiFi units, which are highly directional and have gaps in coverage, the device 10 as depicted herein, is omnidirectional and dual polarized. This is especially important in that devices communicating with the router are frequently held at multiple and moving angles and their onboard antennas thus change frequently in their polarization scheme relative to the fixed positioned antenna on wireless routers. Further, in the case of a MiFi router which must be in operative communication with fixed-positioned cellular towers, the MiFi unit itself, such as in a moving car, is frequently changing its relative polarization position relative to the fixed cellular antenna to which it communicates.

As such, unlike conventional dipole and similar antennas engaged to wireless routers, switches, and MiFi cellular routers, which are in fixed polarization positions and frequently lose signal or have their throughput limited by poor signals due to improper polarization, the device 10 herein, with the multiple elements 17 providing omnidirectional and adaptive polarization relative to cell towers and other communicating devices, maximizes both signal strength and throughput to both engaged computer devices, as well as the communicating cellular towers with the device 10. This significantly increases signal gain to and from the cell towers as well as to and from connected devices such as laptops and pad computers and smartphones.

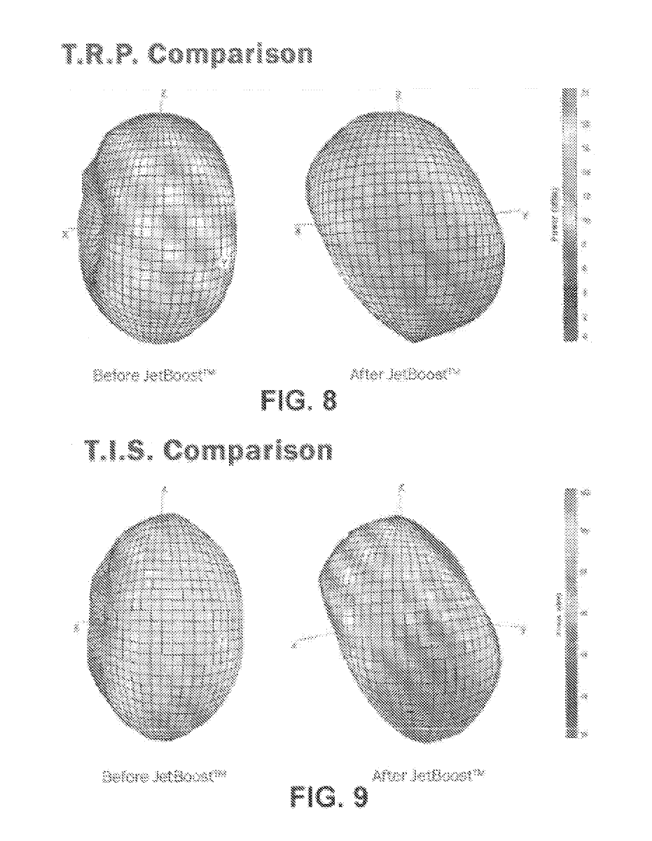

FIGS. 8-10 show the comparisons of gain and signal strength and resulting enhanced throughput for the device 10 communicating with wireless cell sites, as well as the ability to deliver this enhanced throughput of communication to connected wireless electronic devices to the device 10 itself.

Embodiments of the present invention embrace high RX/TX performance. At least some embodiments provide better pattern coverage, lower losses, and/or higher gain. At least some embodiments provide for band coverage of approximately 460 to 960 MHz. FIG. 8 illustrates a T.R.P. comparison. FIG. 9 illustrates a T.I.S. comparison.

While all of the fundamental characteristics and features of the antenna yielding enhanced wireless router communication have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

Thus, as discussed herein, the embodiments of the present invention embrace wireless communications. More particularly, embodiments of the invention relate to an antenna device for employment with conventional wireless routers and more particularly, wireless routers which perform as what is known as mobile hotspots providing network access to a plurality of wirelessly communication computing devices such as portable computers and smartphones.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. An antenna device comprising:
a radiator element that is operatively engageable with an antenna port, wherein when engaged improves transmission and reception capabilities of a wireless router on cellular frequencies and improves multiple communication streams between the antenna device and a connected computer device.
